(19) United States
(12) Patent Application Publication
(10) Pub. No.: US 2013/0057144 A1
(43) Pub. Date: Mar. 7, 2013

(54) FLUORESCENT FLAT PANEL LAMP FOR INCREASED LUMEN OUTPUT

(71) Applicants: Noel Park, San Jose, CA (US); Fu-Min Guan, Shanghai (CN); Steve Johnson, Newburyport, MA (US)

(72) Inventors: Noel Park, San Jose, CA (US); Fu-Min Guan, Shanghai (CN); Steve Johnson, Newburyport, MA (US)

(73) Assignees: MATH BRIGHT TECHNOLOGY CO., LTD., Tahsi, Taoyuan (TW); LUMIETTE INC., San Jose, CA (US)

(21) Appl. No.: 13/697,326

(22) PCT Filed: May 9, 2011
(86) PCT No.: PCT/US2011/035792

§ 371 Date: Nov. 9, 2012

Related U.S. Application Data
(60) Provisional application No. 61/333,636, filed on May 11, 2010.

(51) Int. Cl. H01J 61/16; H01J 61/30; H01J 9/26; H01J 61/12

(52) U.S. Cl. 313/572; 313/643; 313/567; 445/25

(57) ABSTRACT

Embodiments of the present invention generally relate to a fluorescent flat panel lamp. In one aspect, a flat panel lamp is provided. The flat panel lamp includes a substantially flat glass plate. The flat panel lamp further includes a formed plate attached to the substantially flat glass plate. The glass plates are hermetically sealed and define a channel. The channel is configured to hold gas and mercury. The flat panel lamp further includes an electrode at each end of the channel, wherein a ratio of the active area of the channel to a surface area of the electrode is less than 10.

### CROSS-REFERENCE TO RELATED APPLICATIONS

This application claims the benefit of United States provisional patent application Ser. No. 61/333,636, filed May 11, 2010, which is herein incorporated by reference.

### BACKGROUND OF THE INVENTION

1. Field of the Invention

Embodiments of the present invention generally relate to a flat panel lamp. More particularly, the present invention relates to fluorescent flat panel lamp configurations with enlarged electrodes.

2. Description of the Related Art

A conventional flat panel lamp includes a channel having an electrode at each end. The channel and the electrodes are made by connecting a formed glass piece to a flat glass piece or two pieces of formed glass. The formed channel is coated with phosphor and a protective coating while the flat glass is coated with a reflective coating and phosphor. In addition to these coatings, the channel contains gas and mercury. In operation, a voltage is applied to the external electrodes, which causes electrons to migrate through the gas from one end of the channel to the other. The energy created by the electrons changes some of the mercury in the channel from liquid to gas. As more electrons and charged atoms move through the channel, the electrons and charged atoms collide with the gaseous mercury atoms. The gaseous mercury atoms are excited due to the collisions and cause electrons in the mercury atoms to bump up to higher energy levels. Then, as the electrons return to their original energy level, they release light photons which interact with the phosphor to emit light that is in the visible spectrum.

The conventional flat panel lamp generates a limited amount of light due to the configuration of the electrodes and the power applied to the electrodes. For instance, the power applied to the electrodes in the conventional flat panel lamp cannot cause enough electrons to migrate through the gas from one end of the channel to the other in order to change a sufficient amount of mercury in the channel from liquid to gas. If more power is applied to the electrodes to achieve higher brightness, the electrodes get too hot and would subsequently break the glass.

### SUMMARY OF THE INVENTION

Embodiments of the present invention generally relate to a fluorescent flat panel lamp with enlarged electrodes. In one aspect, a flat panel lamp is provided.

The flat panel lamp includes a substantially flat glass plate. The flat panel lamp further includes a formed glass plate attached to the substantially flat glass plate, wherein the substantially flat glass plate and formed glass flat plate are hermetically sealed and define one or more channels. Additionally, the flat panel lamp includes an electrode at each end of the one or more channels, wherein a ratio of an active area of the one or more channels to a surface area of the electrodes is less than 10.

In another aspect, a method of forming a flat panel lamp is provided. The method includes the step of providing a substantially flat glass plate and attaching a formed glass plate to the substantially flat glass plate. The plates define one or more channels with an electrode at each end of the channel, wherein a ratio of an active area of the one or more channels to a surface area of the electrodes is less than 10. The method also includes the step of inserting a fill gas in the one or more channels and hermetically sealing the plates.

In a further aspect, a flat panel lamp is provided that includes two formed glass plates. The glass plates are attached to each other and define one or more channels, wherein a first emitting light portion is disposed on one side of the glass plates and a second emitting light portion is disposed on an opposite side of the glass plates. The flat panel lamp further includes an electrode at each end of the one or more channels, wherein a ratio of an active area of the one or more channels to a surface area of the electrodes is less than 10.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a view illustrating an embodiment of a flat panel lamp.

FIG. 2 is a cross-section view of the flat panel lamp.

FIG. 3 is a cross-section view of a flat panel lamp that includes a first emitting light portion and a second emitting light portion.

### DETAILED DESCRIPTION

Embodiments of the present invention generally relate to a fluorescent flat panel lamp. The flat panel lamp includes a substantially flat glass plate. The flat panel lamp further includes a formed plate attached to the substantially flat glass plate. The glass plates are hermetically sealed and define a channel or channels. The channel(s) are configured to hold gas and mercury. The flat panel lamp further includes an external electrode at each end of the channel(s), wherein a ratio of the active area of the channel, which is the inner surface area of the channel, to a surface area of the electrode is less than 10. This ratio is less than the ratio used in conventional fluorescent flat panel lamps. As a result, fluorescent flat panel lamps having overall configurations that are smaller than conventional fluorescent flat panel lamps are made possible. To better understand the novelty of the fluorescent flat panel lamp of the present invention and the methods of use thereof, reference is hereafter made to the accompanying drawings.

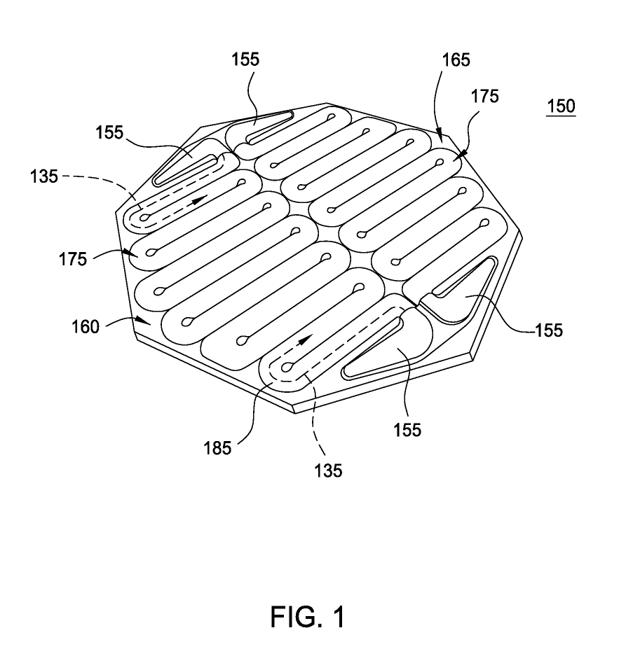

FIG. 1 is a view illustrating an embodiment of a flat panel lamp 150. The flat panel lamp 150 includes a first light portion 160 and a second light portion 165. Each light portion 160, 165 includes a pair of external electrodes 155 that are connected via a channel 175. The channel 175 is defined between a substantially flat glass plate 180 and a formed glass plate 185. The glass plates 180 and 185 are hermetically sealed together. The inner surface of glass plates 180, 185 that define the channel 175 is coated with phosphor and a protective coating. The channel 175 also contains gas and mercury. Further, the channel 175 has a serpentine shape which is used to increase the length of the channel 175 and results in a larger emitting light portion of the flat panel lamp 150. As shown in FIG. 1, the flat panel lamp 150 includes two light portions 160, 165; however, the flat panel lamp 150 may have one light portion or any number of light portions without departing from principles of the present invention.

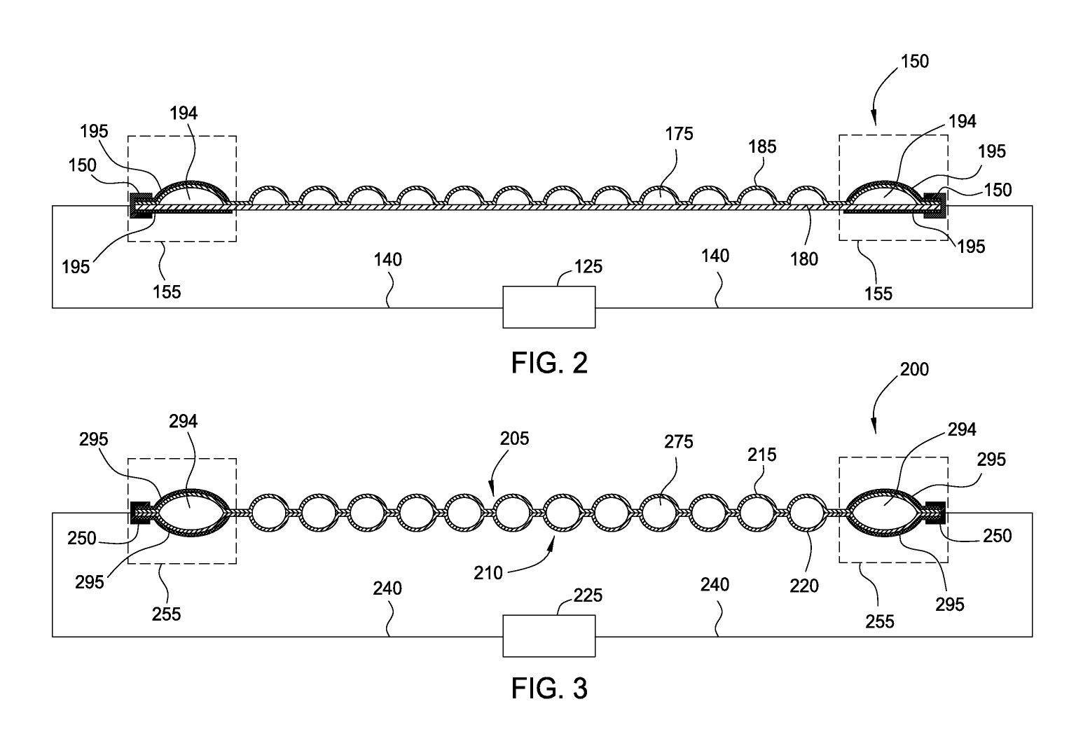

FIG. 2 is a cross-section view of the flat panel lamp. As shown, each external electrode 155 is formed at an end portion of the channel 175 that has an enlarged cross-section relative to other portions of the channel 175. The external electrodes 155 consist of several components. For instance, the external electrodes 155 include an external electrode coating 195 that is a conductive material, such as but not limited to silver paint and applied to either side of the end portion of the channel 175. The external electrodes 155 also include an internal space 194 that is a continuation of channel 175 with only a protective coating, such as but not limited to aluminum oxide. As shown in FIG. 2, a clip 150 is attached to each external electrode 155. The clip 150 electrically connects the top and bottom electrode together. A wire 140 runs from the clip 150 to a ballast 125. During operation, AC power is applied through the wire 140 to the clip 150 and an arc current 135 (see FIG. 1) flows through the channels 175.

The electrodes 155 are capacitively coupled. In this respect, each electrode 155 is similar to a capacitor plate that is connected by dielectric in the form of the glass channel 175 and the discharge. An oscillating voltage is applied to the external electrodes 155, which causes electrons to migrate through the gas from one end of the channel 175 to the other. The energy created by the electrons changes some of the mercury in the channel 175 from liquid to gas and ionizes insert gas atoms. As more electrons and charged inert gas atoms move through the channel 175, the electrons and charged inert gas atoms collide with the gaseous mercury atoms. The mercury atoms are excited due to the collision, which causes electrons in the mercury atoms to bump up to higher energy levels. As the electrons return to their original energy level, the electrons release light photons. When the photon hits a phosphor atom in the phosphor coating of the channel 175, one of the phosphor's electrons jumps to a higher energy level, which causes the atom to heat up. When the phosphor electron falls back to its normal level, it releases energy in the form of another photon which gives off light that is in the visible spectrum.

In the embodiments of the present invention, the surface area of the electrodes 155 has been increased in relation to the area of the emitting portion of the channel 175 as compared to conventional flat panel lamp designs. Table 1 below illustrates the ratio of an active area (e.g., emitting portion) versus an electrode area for several flat panel lamps.

TABLE 1

| | | | electrode |
|---|---|---|---|
| | | | surface area |
| | | | [mm²] (Both |
| | Type | Ratio | Sides) |
| current | 12″ × 3″ | 14.5 | 2,124 |
| | 12″ × 12″ | 16.8 | 8,500 |
| | 24″ × 4′ | 13.9 | 6,374 |
| | 22″ × 5″ | 15.1 | 6,374 |
| new | 8″ Round | 4.0 | 6,772 |
| | 4.75″ | 4.5 | 2,372 |
| | Round | | |
| | 3.75″ | 4.9 | 818 |
| | Round | | |

The Type column in Table 1 lists lamps by outer dimension in inches for the rectangular lamps shown in the “current” section and by diameter for the three lamps shown in the “new” section. The “current” section represents the design of the flat panel lamps currently available in the market. The “new” section represents the new design of the flat panel lamps similar to the one shown in FIG. 1. In the new design, the electrode size of the electrodes 155 of the flat panel lamp 150 is enlarged as a result of enlarging the end portion of the channel 175 relative to the other portions of the channel 175. The enlarged electrodes allow for higher operating currents, which relates to higher power per unit area of lamp without over-heating the electrodes in the octagonal lamps. The ratio column in Table 1 illustrates the ratio of active area versus electrode surface area. In the embodiment illustrated in FIG. 2, the active area and the electrode surface area are measured on a flat plane of the glass plate 180 of the flat panel lamp 150. In the embodiment illustrated in FIG. 3, the active area and the electrode surface area are measured on a flat plane through the center of the flat panel lamp 200. As can be seen from Table 1, the new designs have smaller overall configurations. The inventors have discovered that the reduced ratios of active area to electrode surface area enable the smaller designs to operate with higher power resulting in higher lumen output (e.g., brightness). In one embodiment, a ratio of the active area of the channel to a surface area of the electrode is less than 10 and preferably between 4 and 5.

As previously set forth, gas is contained in the channel 175 defined between the substantially flat glass plate 180 and the formed glass plate 185. The fill gas is used in the channel 175 to allow electrons to migrate from one end of the channel 175 to the other. In order to send a current through the fill gas in a tube, the flat panel lamp 150 is configured to free electrons and ions. Additionally, the flat panel lamp 150 is configured to create a difference in charge between the two ends of the channel 175 (a voltage). Since the atoms naturally maintain a neutral charge, there are typically few ions and free electrons in a gas, which may make it difficult to conduct an electrical current through most gases. To increase the electrical current through the fill gas in the channel 175, the pressure of the fill gas has been set at a predetermined pressure. In one embodiment, the predetermined pressure is greater than 15 Torr, such as 18 Torr. Additionally, the mixture of the fill gas used in the channel 175 also affects the electrical current through the fill gas. The fill gas in the channel 175 may be a mixture of neon gas and argon gas. In one embodiment, the fill gas includes a greater amount of neon than argon. It was found that 80% neon and 20% argon in combination with the pressure of 18 Torr increased the current through the fill gas in the channel 175.

The operating frequency used to operate the flat panel lamp 150 affects the performance of the flat panel lamp 150. The conventional fluorescent lamp operates at an operating frequency between 20 and 30 kHz. An operating frequency above 30 kHz does not change the performance of the conventional fluorescent lamp. However, it was determined that an operating frequency above 30 kHz in the flat panel lamp 150 does increase the performance of the flat panel lamp 150. In one embodiment, the operating frequency used to operate the flat panel lamp 150 is above 40 kHz, such as between 50 and 60 kHz.

The flat panel lamp 150 may have various operating parameters that affect the performance of the flat panel lamp 150. For example, in one embodiment, the following are several operating parameters of the flat panel lamp 150:

1) Voltage: 1500 volts RMS

2) Current: AC

3) Frequency: 50 kHz

4) Gas: 80% neon and 20% argon at a pressure of 18 Torr

These operating parameters in conjunction with the increased electrode size, as set forth in Table 1, allow for higher operating currents, which relate to higher powers per unit area of lamp without over-heating the electrodes.

FIG. 3 is a cross-section view of a flat panel lamp 200 that includes a first emitting light portion 205 and a second emitting light portion 210. The flat panel lamp 200 includes a pair of external electrodes 255 is connected via a channel 275. The channel 275 is defined between a first formed glass plate 215 and a second formed glass plate 220. The glass plates 215 and 220 are hermetically sealed together. The channel 275 has a serpentine shape, substantially similar to the one shown in FIG. 1, which is used to increase the length of the channel 275 and results in a larger first emitting light portion 205 and a larger second emitting light portion 210.

As shown in FIG. 3, each external electrode 255 is formed at an end portion of the channel 275 that has an enlarged cross-section relative to other portions of the channel 275. The external electrodes 255 include the external electrode coating 295 (i.e., a conductive material) and an internal space 294 that is a continuation of the channel 275 with only a protective coating such as aluminum oxide. As shown in FIG. 3, a clip 250 is attached to each external electrode 255. The clip 250 electrically connects the top and bottom electrode together. A wire 240 runs from the clip 250 to a ballast 225. During operation, AC power is applied through the wire 240 to the clip 250 and an arc current flows through the channels 275.

Each external electrode 255 is similar to a capacitor plate that is connected by dielectric in the form of the glass channel 275 and the discharge. As set forth herein, an oscillating voltage is applied to the external electrodes 255, which causes electrons to migrate through the gas from one end of the channel 275 to the other. The energy created by the electrons changes some of the mercury in the channel 275 from liquid to gas and ionizes inert gas atoms. As more electrons and charged inert gas atoms move through the channel 275, the electrons and charged inert gas atoms collide with the gaseous mercury atoms. The mercury atoms are excited due to the collision, which causes electrons in the mercury atoms to bump up to higher energy levels. As the electrons return to their original energy level, the electrons release light photons. When the photon hits a phosphor atom in the phosphor coating of the channel 275, one of the phosphor's electrons jumps to a higher energy level, which causes the atom to heat up. When the phosphor electron falls back to its normal level, it releases energy in the form of another photon, which gives off light that is in the visible spectrum.

Similar to the flat panel lamp 150 described herein, the surface area of the electrodes 255 has been increased in relation to the area of the emitting portion of the channel 275 as compared to conventional flat panel lamp designs. The operating parameters of the flat panel lamp 200 are similar to the operating parameters of the flat panel lamp 150.

While the foregoing is directed to embodiments of the present invention, other and further embodiments of the invention may be devised without departing from the basic scope thereof, and the scope thereof is determined by the claims that follow.

We claim:

1. A flat panel lamp comprising:
a substantially flat glass plate;
a formed glass plate attached to the substantially flat glass plate, wherein the substantially flat glass plate and formed glass flat plate are hermetically sealed and define one or more channels; and
an electrode at each end of the one or more channels, wherein a ratio of an active area of the one or more channels to a surface area of the electrodes is less than 10.

2. The flat panel lamp of claim 1, further comprising a fill gas disposed within the one or more channels, wherein the fill gas includes a mixture of argon and neon with a greater percentage of neon than argon.

3. The flat panel lamp of claim 2, wherein the fill gas includes 80% neon and 20% argon.

4. The flat panel lamp of claim 2, wherein the fill gas has a pressure greater than 15 Torr.

5. The flat panel lamp of claim 1, wherein the flat panel lamp has an operation frequency of greater than 40kHz.

6. The flat panel lamp of claim 1, wherein the flat panel lamp has an operation frequency between 50 kHz and 60kHz.

7. The flat panel lamp of claim 1, wherein the ratio of the active area of the channel to a surface area of the electrode is between 4 and 5.

8. The flat panel lamp of claim 1, further comprising a coating of conductive material disposed on each electrode.

9. The flat panel lamp of claim 1, wherein the one or more channels is a serpentine shape.

10. A method of forming a flat panel lamp, the method comprising;
providing a substantially flat glass plate;
attaching a formed glass plate to the substantially flat glass plate, wherein the plates define one or more channels with an electrode at each end of the channel and wherein a ratio of an active area of the one or more channels to a surface area of the electrodes is less than 10; and
inserting a fill gas in the one or more channels and hermetically sealing the plates.

11. The method of claim 10, further comprising applying a coating of conductive material on each electrode.

12. The method of claim 10, wherein the fill gas includes a mixture of argon and neon with a greater percentage of neon than argon.

13. The method of claim 10, wherein the fill gas has a pressure greater than 15 Torr.

14. A flat panel lamp comprising:
two formed glass plates attached to each other and define one or more channels, wherein a first emitting light portion is disposed on one side of the glass plates and a second emitting light portion is disposed on an opposite side of the glass plates; and
an electrode at each end of the one or more channels, wherein a ratio of an active area of the one or more channels to a surface area of the electrodes is less than 10.

15. The flat panel lamp of claim 14, further comprising a fill gas disposed within the one or more channels, wherein the fill gas includes a mixture of argon and neon with a greater percentage of neon than argon.

16. The flat panel lamp of claim 15, wherein the fill gas has a pressure greater than 15 Torr.

17. The flat panel lamp of claim 15, wherein the fill gas has a pressure of 18 Torr and a mixture of 80% neon and 20% argon.

18. The flat panel lamp of claim 14, wherein the flat panel lamp has an operation frequency of greater than 40 kHz.

19. The flat panel lamp of claim 14, further comprising a coating of conductive material disposed on each electrode. The flat panel lamp of claim 14, wherein the ratio of the active area of the channel to the surface area of the electrodes is between 4 and 5.
